(19) United States
(12) Patent Application Publication
(10) Pub. No.: US 2005/0002520 A1
(43) Pub. Date: Jan. 6, 2005

(54) Housing fabricating mechanism

(75) Inventors: Chin-Kai Sun, Taoyuan (TW); Chia-Ming Hsieh, Taoyuan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 10/873,530

(22) Filed: Jun. 18, 2004

(30) Foreign Application Priority Data
Jun. 19, 2003 (TW) 092116691

(51) Int. Cl. H04M 1/00

(52) U.S. Cl. 379/447

(57) ABSTRACT

A housing fabricating mechanism is used for fabricating a first housing and a second housing of a wireless communication devices, and the housing fabricating mechanism comprises a first fabricating surface of the first housing and a second fabricating surface of the second housing. Where the first fabricating surface of the first housing comprises a first hook and an inserted ditch, the second fabricating surface of the second housing comprises a second hook, an inserting end and a stopper for combining with the first housing fabricating surface. The second hook is located in the opposite position of the first hook and has an opening on the second housing for accommodating and wedging the first hook when the first housing and the second housing are fabricated together. The stopper is used for plugging the opening when the first housing and the second housing are fabricated together so as to prevent the first hook from detaching from the second hook after the two are wedged together.

### BACKGROUND OF THE INVENTION

1. Field of the Invention

The present invention relates to a housing fabricating mechanism, particularly, to a housing fabrication scheme of wireless communication device.

2. Description of the Prior Art

Mobile phone is one of the most popular electronic products for consumer. A mobile phone with changeable cosmetic housings can provide a number of appearances and thus obtains an increasing popularity by the consumers.

Among foldable mobile phones in the market, only Motorola V66 and Giya SL500 have changeable faceplate. The variable part is only limited to the faceplate on one of the housing, and not the entire housing. With foldable mobile phones of other name brands, the user needs to take out the screws on the mobile phone housing to change the external parts, which is even more inconvenient.

Therefore, Motorola launched another phone model, the T720, which has changeable covers. But this model uses a conventional wedge structure, its strength is not enough, and it is easily detached with the main body of the mobile phone.

The present invention sets out to improve the above design, so that the mobile phone can easily change it's entire cover and prevents the changeable cover from being detached easily from the mobile phone.

### SUMMARY OF THE INVENTION

The objective of the present invention is to provide a housing fabricating mechanism for changing the cosmetic housing of a folding mobile phone so as to provide a variety of appearances for the foldable mobile phone.

Another objective of the present invention is to provide a housing fabricating mechanism for improving the drawbacks of the prior art, preventing the faceplates from being easily detached from the mobile phone. The present invention is a housing fabricating mechanism for combining a first housing and a second housing of a wireless communication device. The housing fabricating mechanism comprises a first fabricating surface of the first housing and a second fabricating surface of the second housing. Wherein the first fabricating surface of the first housing comprises a first hook and an inserted ditch, the second fabricating surface of the second housing comprises a second hook, an inserting end and a stopper. The second hook is located at the corresponding opposite position of the first hook; it also has an opening on the second housing for accommodating and wedging the first hook when the two hooks fabricate together. The inserting end is located at the corresponding opposite position of the inserted ditch for wedging the two together. The stopper is used to squeeze into the opening when the first housing and the second housing fabricate together so as to prevent the first hook from departing from the second hook after they are wedged together.

The objective of the present invention is to easily change the faceplate of the mobile phone by fabricating the first hook and the second hook and assemble the inserting end and the inserted ditch. Some of the changeable parts are obviously more advanced than the prior art; besides, the combination of the stopper and the opening can prevent the housing from detaching the mobile phone.

The advantage and spirit of the invention may be understood by the following recitations together with the appended drawings.

### BRIEF DESCRIPTION OF THE APPENDED DRAWINGS

FIG. 1 is a blown up view of a housing fabricating mechanism according to the present invention.

FIG. 2 is a schematic diagram of the fabrication of a first hook, a second hook and a stopper according to an embodiment of this invention.

FIG. 3 is a schematic diagram of the fabrication of a first hook, the second hook and a stopper, according to another preferred embodiment of the present invention.

FIG. 4 is a schematic diagram that an inserting end inserts into an inserted ditch.

FIG. 5 is a schematic diagram that the first hook inserts into the second hook.

FIG. 6 is a schematic diagram of the wedging state of the first hook and the second hook.

FIG. 7 is a schematic diagram that the stopper inserts into the opening.

FIG. 8 is a schematic diagram of the housing fabricating mechanism after assembling.

### DETAILED DESCRIPTION OF THE INVENTION

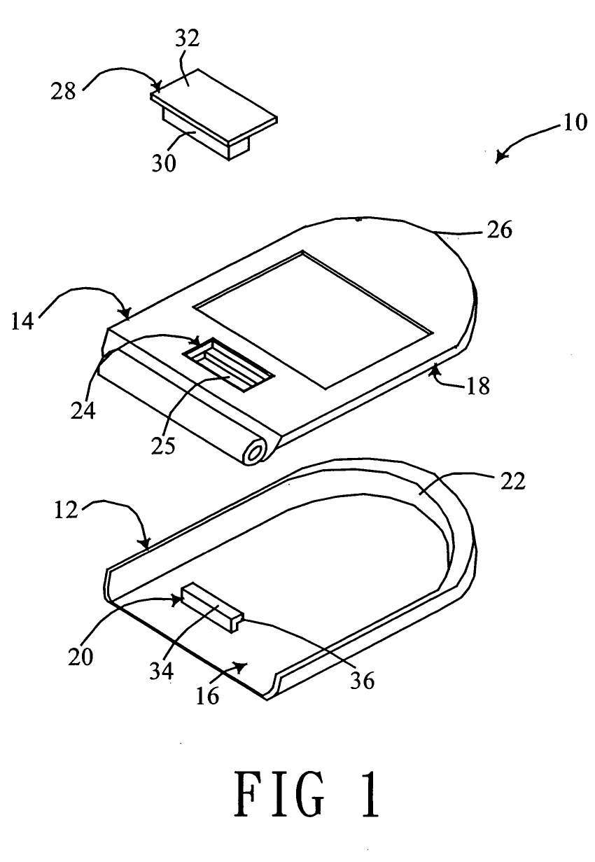

Please refer to FIG. 1. The FIG. 1 is a blown up view of the housing fabricating mechanism 10 according to the present invention. The housing fabricating mechanism 10 is used for fabricating a first housing 12 and a second housing 14 of a wireless communication device. The first housing 12 and the second housing 14 comprise a first fabricating surface 16 and a second fabricating surface 18 respectively. The first fabricating surface 16 is facing the second fabricating surface 18 when the first housing 12 and the second housing 14 fabricate together.

A first hook 20 and an inserted ditch 22 are located on the first fabricating surface 16 of the first housing 12. A second hook 24 and an inserting end 26 are located on the second fabricating surface 18 of the second housing 14 that fabricates with the first fabricating surface 16. The second hook 24 is located at the corresponding opposite position of the first hook 20, and it has an opening 25 on the second housing 14 for accommodating and wedging the first hook 20 when the first housing 12 and the second housing 14 fabricate together. The inserting end 26 is located at the corresponding opposite position of the inserted ditch 22 for wedging the inserted ditch 22. After wedging the first hook 20 and the second hook 24, the inserted ditch 22 and the inserting end 26, these two parts can structurally constrain each other to make the entire structure of the housing fabricating mechanism 10 stronger and not being easily detached. Furthermore, the present invention has a stopper 28 for plugging the opening 25 after the first housing 12 and the second housing 14 fabricate together; this is to prevent the first hook 20 from detaching from the second hook 24.

In the present embodiment, the housing fabricating mechanism 10 comprises an inserting end 26 and an inserted ditch 22. However, the quantity of inserted ditch 22 and inserting end 26 is not be restricted to be one; the number of the combination of the inserting end 26 and the inserted ditch 22 can be increased depending on the cosmetic and the structural design of the mobile phone. The inserted ditch 22 and the inserting end 26 can swap positions each other. That is, the inserting end 26 and the inserted ditch 22 can be located on the first housing 12 and the second housing 14 respectively. In the same way, the first hook 20 and the second hook 24 can also swap positions. That is, the first hook 20 and the second hook 24 can be located on the second housing 14 and the first housing 12, respectively.

As shown in FIG. 1, the stopper 28 comprises a plugging part 30 and an outer part 32; wherein the plugging part 30 is used for plugging the opening 25, the outer part 32 can be designed as a cosmetic part of the second housing 14. In a preferred embodiment of the present invention, the outer part 32 is a name plate, and the plugging part 30 is made of rubber. The room, which the first housing 12 and the second housing 14 constructed, can be used for accommodating a display screen or a motherboard with a keypad. The second housing 14 further comprises a window or a plurality of key openings, allowing the display screen or the keypad to be shown on the external of the second housing 14.

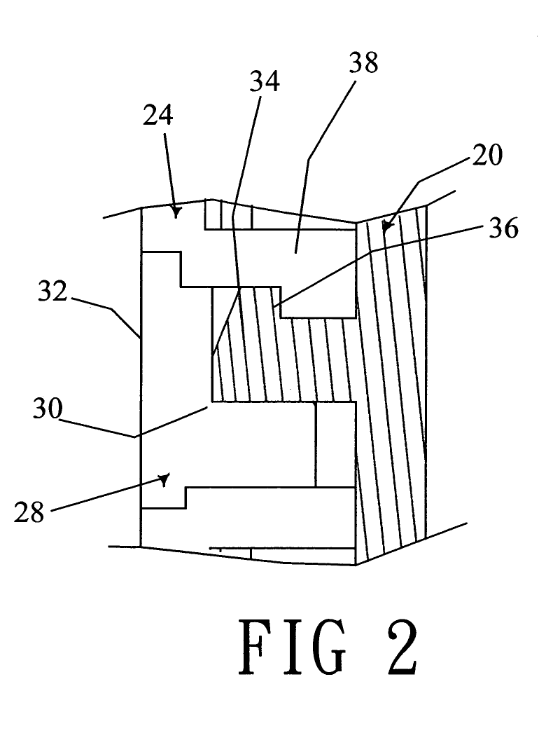

Please refer to FIG. 2; FIG. 2 is a schematic diagram of the fabrication of a first hook 20, a second hook 24 and a stopper 28 according to an embodiment of this invention. The first hook 20 comprises a tine 34 and a wedge part 36, and wherein the tine 34 is used for making the first hook 20 inserts easily onto the second hook 24, the wedge part 36 is used for making the first hook 20 wedges firmly onto the second hook 24.The tine 34 of the first hook 20 can be designed as a ball-like structure. The second hook 24 can be designed with a partition surrounding at the bottom of the opening 25 for wedging the first hook 20. The wedging location of the first hook 20 and the second hook 24 can be designed at any position around the opening 25.

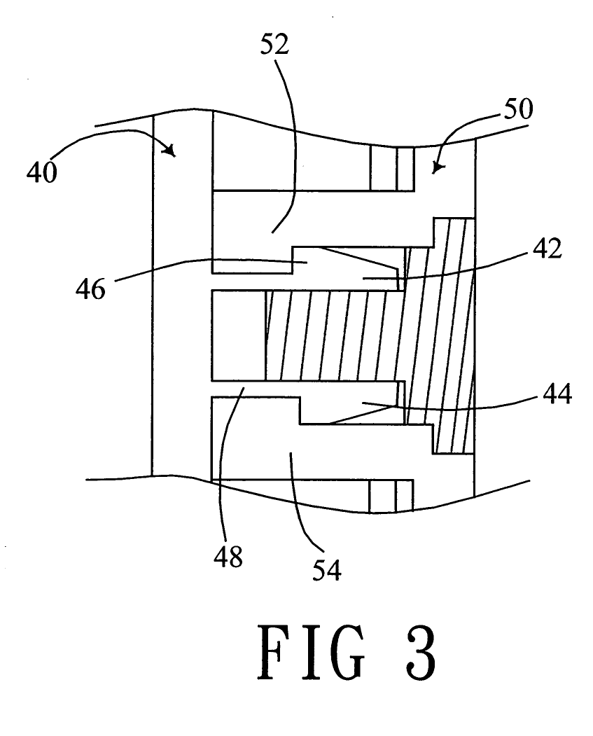

Please refer to FIG. 3; FIG. 3 is a schematic diagram of the fabrication of a first hook 40, a second hook 50 and the stopper, according to another preferred embodiment of the present invention; wherein the first hook 40 comprises an upper tine 42, a lower tine 44, an upper wedge part 46 and a lower wedge part 48, the second hook 50 comprises an upper partition 52 and a lower partition 54. The upper tine 42 and the lower tine 44 are used for making the first hook 40 inserts easily onto the second hook 50. The upper wedge part 46 and the lower wedge part 48 insert separately onto the upper partition 52 and the lower partition 54 of the second hook 50 after the first hook 40 inserts into the second hook 50. This embodiment uses the two tines and two wedge parts, working along with the two partitions, to strengthen the housing structure; this makes the housing fabricating mechanism 10 of the present invention not easily come apart.

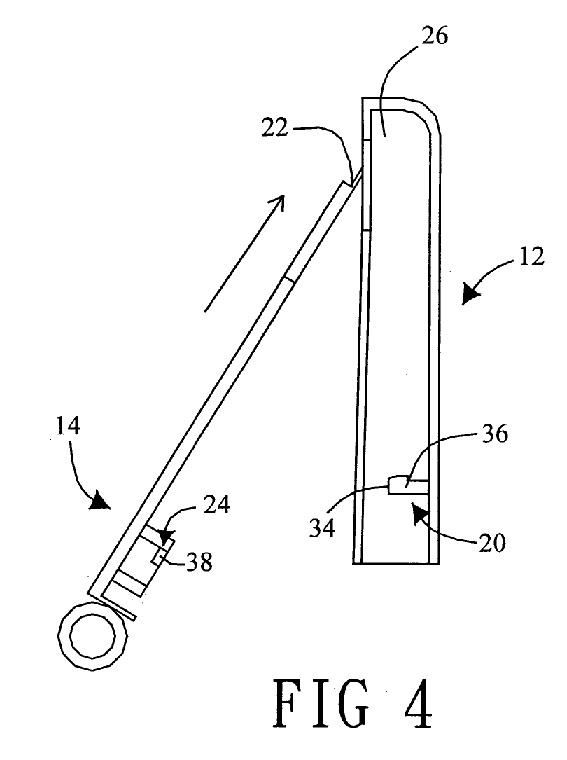

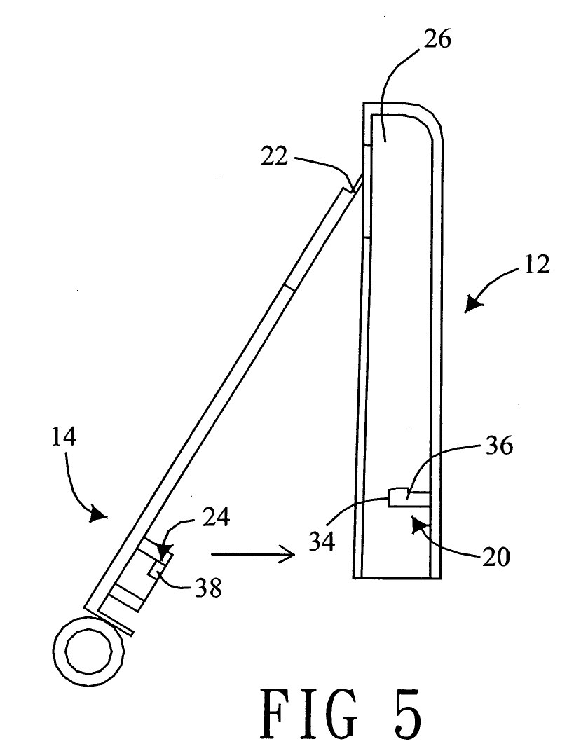

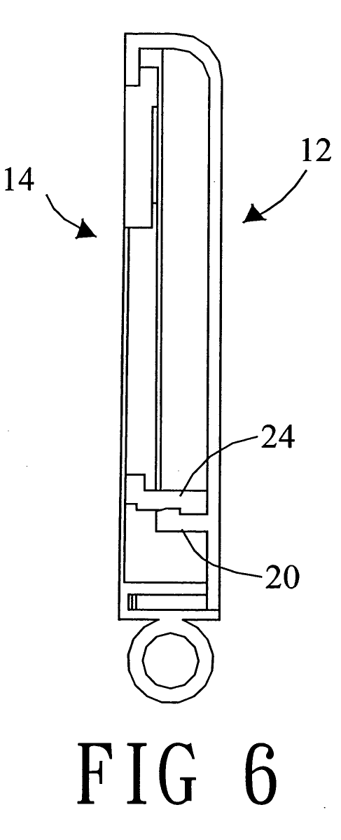

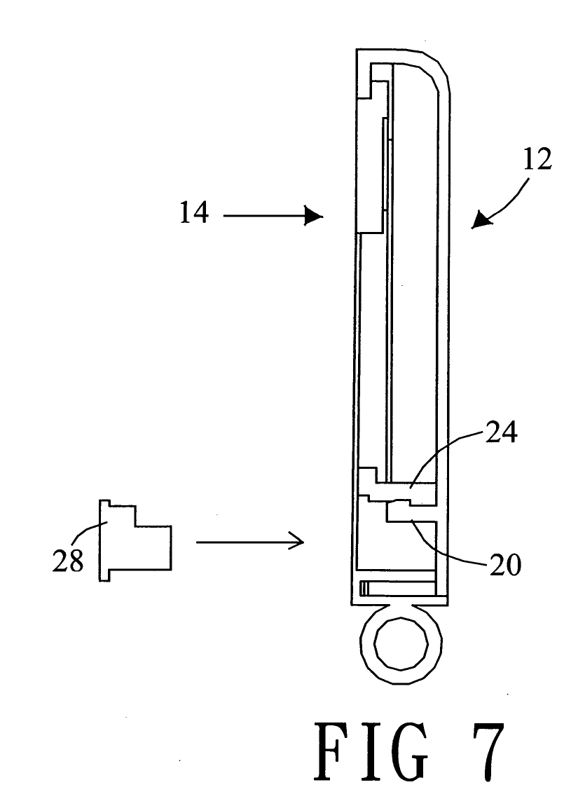

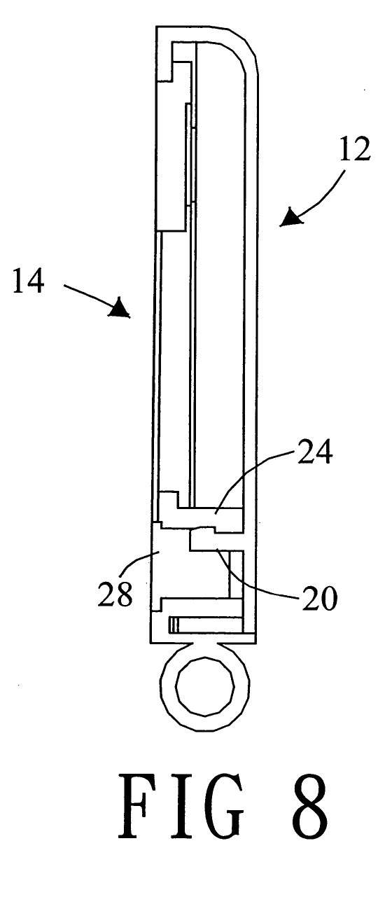

Please refer to FIG. 4 to FIG. 8. FIG. 4 is a schematic diagram that the inserting end 26 of FIG. 1 inserts into the inserted ditch 22. FIG. 5 is a schematic diagram that the first hook 20 of FIG. 1 inserts onto the second hook 24. FIG. 6 is a schematic diagram of the wedging state of the first hook 20 and the second hook 24. FIG. 7 is a schematic diagram that the stopper 28 inserts into the opening 28. FIG. 8 is a schematic diagram of the housing fabricating mechanism 10 assembling. FIG. 4 to FIG. 8 shows the procedure of successive fabrication of the housing fabricating mechanism 10. The arrows in the diagrams represent directions of motions when components are fabricated in the procedure.

As shown in FIG. 4, FIG. 5 and FIG. 6, the inserting end 26 of the second housing 14 inserts into the inserted ditch 22 of the first housing 12; with the inserted ditch 22 regarded as an axis, it makes the second hook 24 of the second housing 14 moves in the indicated direction. When the second hook 24 contacts the first hook 20, the tine 34 of the first hook 20 smoothly inserts into the second hook 24 and then wedges the second hook 24 by the wedge part 36.

As shown FIG. 7 and FIG. 8, after the first housing 12 and the second housing 14 are fabricated together, a user can plug the stopper 28 into the opening 25 to prevent the first hook 20 disengaging form the second hook 24.

In conclusion, the housing fabricating mechanism of the present invention provides a pair of the first and second hook, coupling with the inserting end and the inserted ditch, to make the strength of whole structure stronger than the prior art. Because the structure in this invention can be easily fabricated two housings together, users can change the faceplate of the mobile phone easily. Moreover, the second hook has a specific design of plugging the opening with a stopper, thus preventing the first hook from detaching from the second hook even if the elasticity is decayed; besides, the surface of the stopper can be decorated, further embellishing the housing appearance.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A housing fabricating mechanism for fabricating a first housing and a second housing of a wireless communication device, the housing fabricating mechanism comprising:
a first fabricating surface of the first housing, said first fabricating surface comprising:
a first hook; and
an inserted ditch;
a second fabricating surface of the second housing for combining with the first fabricating surface, said second fabricating surface comprising:
a second hook located in the opposite position of the first hook and formed an opening on the second housing for accommodating and wedging the first hook; and
an inserting end located in the opposite position of the inserted ditch for wedging the inserted ditch; and
a stopper for inserting into the opening to prevent the first hook from detaching from the second hook after fabricating the first housing and the second housing.

2. The housing fabricating mechanism of claim 1, wherein the first housing and the second housing construct a room for accommodating an object.

3. The housing fabricating mechanism of claim 2, wherein the object is a display.

4. The housing fabricating mechanism of claim 3, wherein the second housing comprises a window for displaying the display.

5. The housing fabricating mechanism of claim 2, wherein the object is a motherboard with a keypad.

6. The housing fabricating mechanism of claim 5; the second housing further comprising a plurality of key openings for displaying the keypads.

7. The housing fabricating mechanism of claim 1, wherein the first hook comprises a tine and a wedge part, wherein the tine facilitates the first hook inserting into the second hook, and the wedge part makes the first hook wedge the second hook.

8. The housing fabricating mechanism of claim 7, wherein the second hook has a partition at the bottom of the opening to wedge the wedge part after the first hook is inserted into the second hook.

9. The housing fabricating mechanism of claim 1, wherein the top of the first hook is a ball-like structure.

10. The housing fabricating mechanism of claim 13, wherein the second hook is a partition surrounding the bottom of the opening for wedging the ball-like structure after the first hook is inserted into the second hook.

11. The housing fabricating mechanism of claim 1, wherein the first hook comprises a first tine, a second tine, a first wedge part and a second wedge part, and wherein the first tine and the second tine are used for facilitating the first hook inserting into the second hook, and the first wedge part and the second wedge part are used for wedging the second hook after the first hook inserting into the second hook.

12. The housing fabricating mechanism of claim 11, wherein the second hook comprises a first partition and a second partition at the bottom of the opening for respectively wedging the first wedge part and the second wedge part after the first hook is inserted into the second hook.

13. A fabricating mechanism for fabricating a first housing and a second housing of a wireless communication device; the fabricating mechanism comprises a first hook, a second hook, a inserting end, an inserted ditch and a stopper, wherein the first hook and the second hook are located separately at the first housing and the second housing, and the inserting end and the inserted ditch are located separately at the first housing and the second housing, wherein the first housing and the second housing are fabricated together by wedging the first hook and the second hook, as well as by wedging the inserting end and the inserting ditch; wherein the second hook forms an opening on the second housing to accommodate and wedge the first hook, the stopper is used to plug the opening when the first housing and the second housing are fabricated together so as to prevent the first hook from detaching from the second hook after the first hook is wedged to the second hook.

14. The housing fabricating mechanism of claim 13, wherein the first hook comprises a tine and a wedge part, wherein the tine facilitates the first hook inserting into the second hook and the wedge part makes the first hook wedge the second hook.

15. The housing fabricating mechanism of claim 14, wherein the second hook has a partition at the bottom of the opening to wedge the wedge part after the first hook is inserted into the second hook.

16. The housing fabricating mechanism of claim 14, wherein the top of the first hook is a ball-like structure.

17. The housing fabricating mechanism of claim 16, wherein the second hook comprises a partition surrounding the bottom of the opening for wedging the first hook after the first hook is inserted into the second hook.

18. The housing fabricating mechanism of claim 13, wherein the first hook comprises a first tine, a second tine, a first wedge part and a second wedge part, wherein the first tine and the second tine are used for facilitating the first hook inserting into the second hook, and the first wedge part and the second wedge part are used for wedging the second hook after the first hook is inserted into the second hook.
